(19) United States
(12) Patent Application Publication
(10) Pub. No.: US 2010/0050983 A1
(43) Pub. Date: Mar. 4, 2010

(54) FOUR-STROKE INTERNAL COMBUSTION ENGINE WITH NOVEL INTAKE AND EXHAUST STROKES

(76) Inventor: Pan-Our CHOU, Yangmei Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/502,275

(22) Filed: Jul. 14, 2009

(30) Foreign Application Priority Data
Aug. 27, 2008 (TW) 97132753

(51) Int. Cl. F02B 75/02; F02M 35/10

(52) U.S. Cl. 123/317; 123/184.56

(57) ABSTRACT

A four-stroke internal combustion engine includes a first intake manifold in communication with an intake port of a cylinder. A crankshaft chamber is in communication with a cylinder bore of the cylinder and includes an inlet port adjacent the cylinder bore. A second intake manifold is in communication with the crankshaft chamber for supplying air or gas into the cylinder bore via the inlet port during a second stage of an intake stroke of a piston. An exhaust port of the cylinder is opened during a second stage of a power stroke to perform a first-stage discharge of exhaust gas. Air or gas is supplied into the cylinder bore via the inlet port during a third stage of the power stroke to perform a second-stage discharge of the exhaust gas. Exhaust gas not discharged during the third stage of the power stroke is discharged during an exhaust stroke.

### BACKGROUND OF THE INVENTION

The present invention relates to a four-stroke internal combustion engine and, more particularly, to a four-stroke internal combustion engine with novel intake and exhaust strokes for increasing the power and enhancing the performance of the engine by speeding up discharge of exhaust gas.

Efficient use of energy and high-power internal combustion engines are always the most important issues around the world due to limited oil resources. FIG. 19 shows a conventional four-stroke engine including a cylinder 80 having a cylinder bore 81 in communication with a crankshaft chamber 82. A piston 84 is reciprocatingly received in the cylinder bore 81 and is connected by a connecting rod 83 in the crankshaft chamber 82 to a crankshaft 92. The cylinder 80 further includes an intake port 86 in communication with an intake manifold 88. The cylinder 80 further includes an exhaust port 87 in communication with an exhaust manifold 89. A spark plug 85 is mounted to the cylinder 80. A carburetor 90 is mounted in the intake manifold 88, allowing mixing of fuel with air. During an intake stroke, the piston 84 moves downward and the air-fuel mixture enters the cylinder bore 81 while the intake port 86 is open. During a compression stroke, the intake port 86 is closed and the air-fuel mixture is compressed by the piston 84 that moves upward. During a power (or combustion) stroke, the air-fuel mixture is combusted. The combusted gas expands to move the piston 84 downward. During an exhaust stroke, the exhaust port 87 is open, and the exhaust gas after combustion is discharged via the exhaust port 87 during upward movement of the piston 84. The four strokes repeat in sequence to drive the crankshaft 92 to rotate. The difference between currently available four-stroke engines and the conventional four-stroke engine is not big. However, several disadvantages still exist. As an example, the exhaust gas can not be effectively discharged during the exhaust stroke, reducing the intake efficiency and adversely affecting the power of the engine.

Thus, a need exists for a four-stroke internal combustion engine providing increased power and enhanced performance.

### BRIEF SUMMARY OF THE INVENTION

In a first aspect of the present invention, a four-stroke internal combustion engine includes a cylinder having a cylinder bore, an intake port in communication with the cylinder bore, and an exhaust port in communication with the cylinder bore. A piston is received in the cylinder bore and reciprocatingly moveable between a top dead center and a bottom dead center. The piston includes an intake stroke, a compression stroke, a power stroke, and an exhaust stroke. A crankshaft chamber is in communication with the cylinder bore and includes an inlet port adjacent the cylinder bore. A crankshaft is rotatably received in the crankshaft chamber. A connecting rod includes a first end coupled to the piston and a second end coupled to the crankshaft. A first intake manifold is in communication with the intake port. An exhaust manifold is in communication with the exhaust port. A second intake manifold is in communication with the crankshaft chamber.

The intake port is open and the exhaust port is closed during the intake stroke. A first gas enters the cylinder bore via the intake port. The intake stroke includes a first stage and a second stage. The first stage of the intake stroke includes movement of the piston from the top dead center to an inlet port position about 25°-35° before the bottom dead center. The second stage of the intake stroke includes movement of the piston from the inlet port position to the dead bottom center. The inlet port is covered by the piston during the first stage of the intake stroke. The inlet port is not covered by the piston during the second stage of the intake stroke. A second gas in the crankshaft chamber flows into the cylinder bore via the inlet port during the second stage of the intake stroke.

The intake port and the exhaust port are closed during the compression stroke of the piston. The first gas is compressed during the compression stroke. The power stroke includes a first stage, a second stage, and a third stage. The first stage of the power stroke includes movement of the piston from the top dead center to an exhaust position about 35°-45° before the bottom dead center. The second stage of the power stroke includes movement of the piston from the exhaust position to the inlet port position. The third stage of the power stroke includes movement of the piston from the inlet port position to the dead bottom center. The intake port and the exhaust port are closed and the inlet port is covered by the piston during the first stage of the power stroke. The first gas is combusted at a beginning of the first stage of the power stroke. The exhaust port is open and the intake port is closed and the inlet port is covered by the piston during the second stage of the power stroke. A portion of exhaust gas after combustion of the first gas is discharged via the exhaust port during the second stage of the power stroke, accomplishing a first stage of discharge of the exhaust gas. The exhaust port is open and the intake port is closed and the inlet port is not covered by the piston during the third stage of the power stroke, and the second gas in the crankshaft chamber enters the cylinder bore via the inlet port to perform a second-stage discharge of the exhaust gas via the exhaust port. The exhaust port is opened and the inlet port closed during the exhaust stroke. The exhaust gas not discharged in the third stage of the power stroke is discharged via the exhaust port during the exhaust stroke, and fresh second gas enters the crankshaft chamber via the second intake manifold during the exhaust stroke. In a preferred form, a check valve is mounted on the second intake manifold. The check valve allows flow of the second gas from the second intake manifold into the crankshaft chamber and does not allow flow of the second gas from the crankshaft chamber into the second intake manifold.

In a second aspect of the present invention, a four-stroke internal combustion engine includes a cylinder having a cylinder bore, an intake port in communication with the cylinder bore, and an exhaust port in communication with the cylinder bore. A piston is received in the cylinder bore and reciprocatingly moveable between a top dead center and a bottom dead center. The piston includes an intake stroke, a compression stroke, a power stroke, and an exhaust stroke. A crankshaft chamber is in communication with the cylinder bore and includes an inlet port adjacent the cylinder bore. A crankshaft is rotatably received in the crankshaft chamber. A connecting rod includes a first end coupled to the piston and a second end coupled to the crankshaft. A first intake manifold is in communication with the intake port for supplying a first gas into the cylinder bore via the intake port. An exhaust manifold is in communication with the exhaust port. A second intake manifold includes an end connected to and in communication with the inlet port. An air compressor is mounted on the second intake manifold. The air compressor allows flow of a second gas from the second intake manifold into the inlet port and does not allow flow of the second gas from the inlet port into the second intake manifold.

The intake port is open and the exhaust port is closed during the intake stroke. The first gas enters the cylinder bore via the intake port. The intake stroke includes a first stage and a second stage. The first stage of the intake stroke includes movement of the piston from the top dead center to an inlet port position about 25°-35° before the bottom dead center. The second stage of the intake stroke includes movement of the piston from the inlet port position to the dead bottom center. The inlet port is covered by the piston during the first stage of the intake stroke. The inlet port is not covered by the piston during the second stage of the intake stroke. The air compressor supplies the second gas from the second intake manifold into the cylinder bore via the inlet port during the second stage of the intake stroke.

The intake port and the exhaust port are closed during the compression stroke of the piston. The first gas is compressed during the compression stroke. The power stroke includes a first stage, a second stage, and a third stage. The first stage of the power stroke includes movement of the piston from the top dead center to an exhaust position about 35°-45° before the bottom dead center. The second stage of the power stroke includes movement of the piston from the exhaust position to the inlet port position. The third stage of the power stroke includes movement of the piston from the inlet port position to the dead bottom center. The intake port and the exhaust port are closed and the inlet port is covered by the piston during the first stage of the power stroke. The first gas is combusted at a beginning of the first stage of the power stroke. The exhaust port is open and the intake port is closed and the inlet port is not covered by the piston during the second stage of the power stroke. A portion of exhaust gas after combustion of the first gas is discharged via the exhaust port during the second stage of the power stroke, accomplishing a first stage of discharge of the exhaust gas. The exhaust port is open and the intake port is closed and the inlet port is not covered by the piston during the third stage of the power stroke, and the air compressor supplies the second gas from the second intake manifold into the cylinder bore via the inlet port to perform a second-stage discharge of the exhaust gas via the exhaust port. The exhaust port is opened and the inlet port is closed during the exhaust stroke. The exhaust gas not discharged in the third stage of the power stroke is discharged via the exhaust port during the exhaust stroke.

By providing the second intake manifold in communication with the crankshaft chamber or in direction communication with the inlet port and by supplying the second gas into the cylinder bore via the inlet port, two-stage intake and three-stage discharge of exhaust gas can be performed, eliminating the problem of inefficient discharge of the exhaust gas encountered in conventional four-stroke internal combustion engines.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a cross sectional view of a four-stroke internal combustion engine of a first embodiment according to the preferred teachings of the present invention.

FIG. 2 shows a cross sectional view of the engine of FIG. 1, illustrating a first-stage intake of an intake stroke of the engine.

FIG. 3 shows a cross sectional view of the engine of FIG. 1, illustrating a second-stage intake of the intake stroke of the engine.

FIG. 4 shows a cross sectional view of the engine of FIG. 1, illustrating a compression stroke of the engine.

FIG. 5 shows a cross sectional view of the engine of FIG. 1, illustrating a power stroke of the engine.

FIG. 6 shows a cross sectional view of the engine of FIG. 1, illustrating a first-stage discharge of exhaust gas during the power stroke.

FIG. 7 shows a cross sectional view of the engine of FIG. 1, illustrating a second-stage discharge of the exhaust gas during the power stroke.

FIG. 8 shows a cross sectional view of the engine of FIG. 1, illustrating an exhaust stroke of the engine.

FIG. 9 shows a cross sectional view of the engine of FIG. 1 with the piston at its top dead center.

FIG. 10 shows a cross sectional view of a four-stroke internal combustion engine of a second embodiment according to the preferred teachings of the present invention.

FIG. 11 shows a cross sectional view of a four-stroke internal combustion engine of a third embodiment according to the preferred teachings of the present invention, illustrating a first-stage intake of an intake stroke of the engine.

FIG. 12 shows a cross sectional view of the engine of FIG. 11, illustrating a second-stage intake of the intake stroke of the engine.

FIG. 13 shows a cross sectional view of the engine of FIG. 11, illustrating a compression stroke of the engine.

FIG. 14 shows a cross sectional view of the engine of FIG. 11, illustrating a power stroke of the engine.

FIG. 15 shows a cross sectional view of the engine of FIG. 11, illustrating a first-stage discharge of exhaust gas during the power stroke.

FIG. 16 shows a cross sectional view of the engine of FIG. 11, illustrating a second-stage discharge of the exhaust gas during the power stroke.

FIG. 17 shows a cross sectional view of the engine of FIG. 11, illustrating an exhaust stroke of the engine.

FIG. 18 shows a cross sectional view of the engine of FIG. 11 with the piston at its top dead center.

FIG. 19 shows a cross sectional view of a conventional four-stroke internal combustion engine.

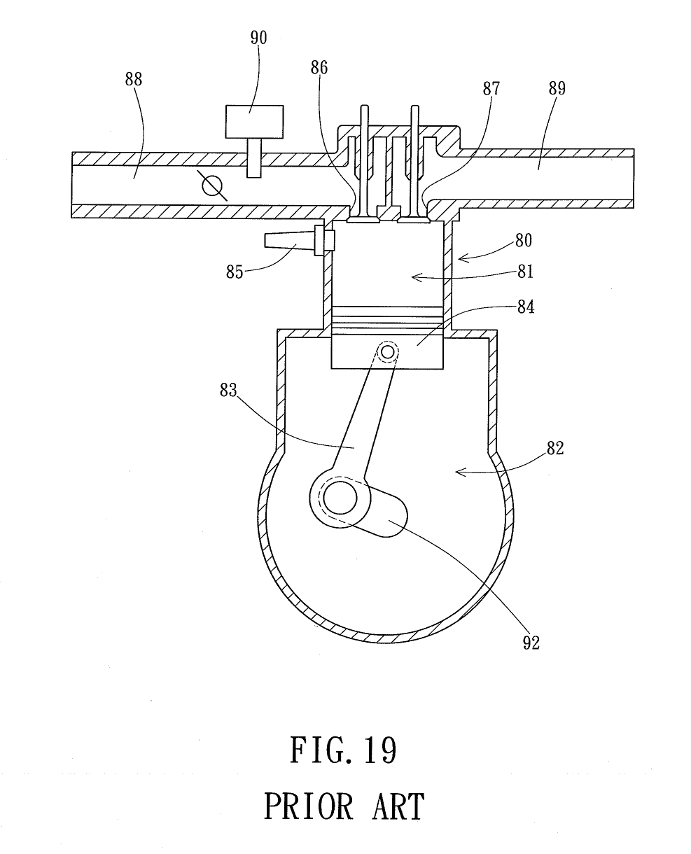

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

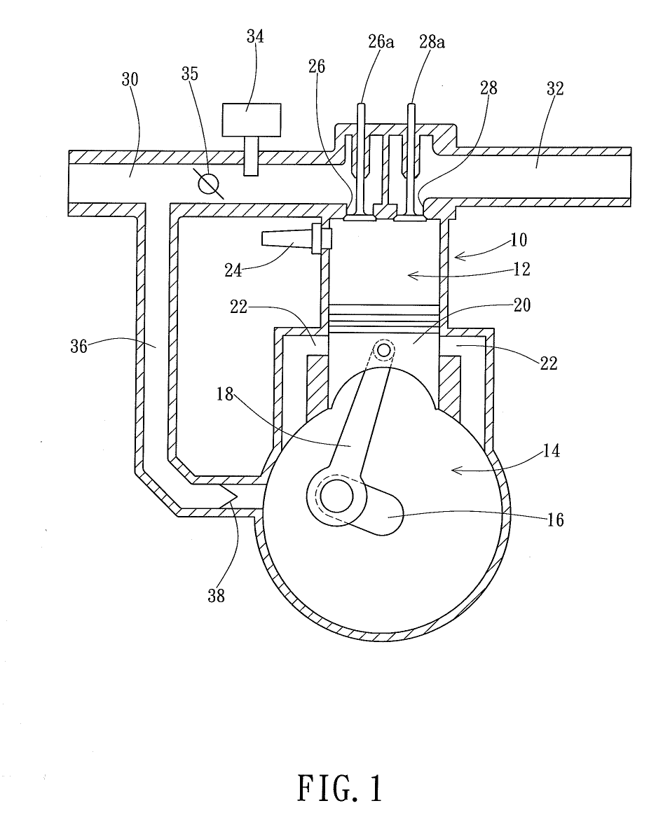

A four-stroke internal combustion engine of a first embodiment according to the preferred teachings of the present invention is shown in FIGS. 1-9. The engine includes a cylinder 10 having a cylinder bore 12 in communication with a crankshaft chamber 14. A crankshaft 16 is rotatably received in the crankshaft chamber 14. A connecting rod 18 has an end pivotably connected to the crankshaft 16. The other end of the connecting rod 18 is connected to a piston 20 reciprocatingly received in the cylinder bore 12. The crankshaft chamber 14 includes an inlet port 22 adjacent an end of the cylinder 10 and in communication with the cylinder bore 12. The other end of the cylinder 10 is opposite to the crankshaft chamber 14 and spaced from the end of the cylinder 10 along an axis along which the cylinder 10 extends and includes an intake port 26 and an exhaust port 28. An intake valve 26a is mounted in the intake port 26 to control opening and closing of the intake port 26. An exhaust valve 28a is mounted in the exhaust port 28 to control opening and closing of the exhaust port 28. Also mounted to the end of the cylinder 10 is a spark plug 24. The intake port 26 is in communication with a first intake manifold 30. The exhaust port 28 is in communication with an exhaust manifold 32. A carburetor 34 and a throttle 35 are mounted in the first intake manifold 30, allowing mixing of fuel with air and controlling the fuel/air ratio.

A second intake manifold 36 is interconnected between the first intake manifold 30 and the crankshaft chamber 14. Specifically, an end of the second intake manifold 36 is in communication with the first intake manifold 30 at a location upstream of the throttle 35. The other end of the second intake manifold 36 is in communication with the crankshaft chamber 14. The inlet port 22 is intermediate the cylinder bore 12 and the other end of the second intake manifold 36 along the axis. A check valve 38 is mounted in the second intake manifold 36 and adjacent the other end of the second intake manifold 36, allowing air to flow from the second intake manifold 36 to the crankshaft chamber 14 and preventing air from flowing from the crankshaft 14 into the second intake manifold 36. It can be appreciated that the check valve 38 can be located in other locations of a passageway formed by the second intake manifold 36 and the crankshaft chamber 14. As an example, the check valve 38 can be mounted in the crankshaft chamber 14 adjacent the other end of the second intake manifold 36.

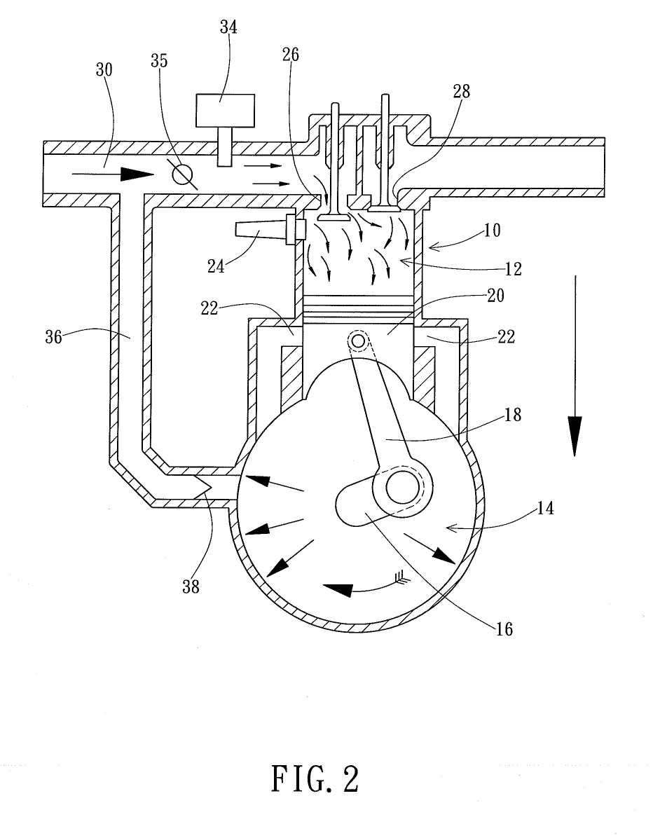

With reference to FIG. 2, during a first stage of an intake stroke, the intake port 26 is open and the exhaust port 28 is closed. The piston 20 moves from its top dead center toward its bottom dead center. Air/fuel mixture from the first intake manifold 30 and the carburetor 34 is drawn into the cylinder bore 12. Note that the check valve 38 is closed during the first stage of the intake stroke, so that air in the crankshaft chamber 14 is compressed. Furthermore, the inlet port 22 is covered by the piston 20.

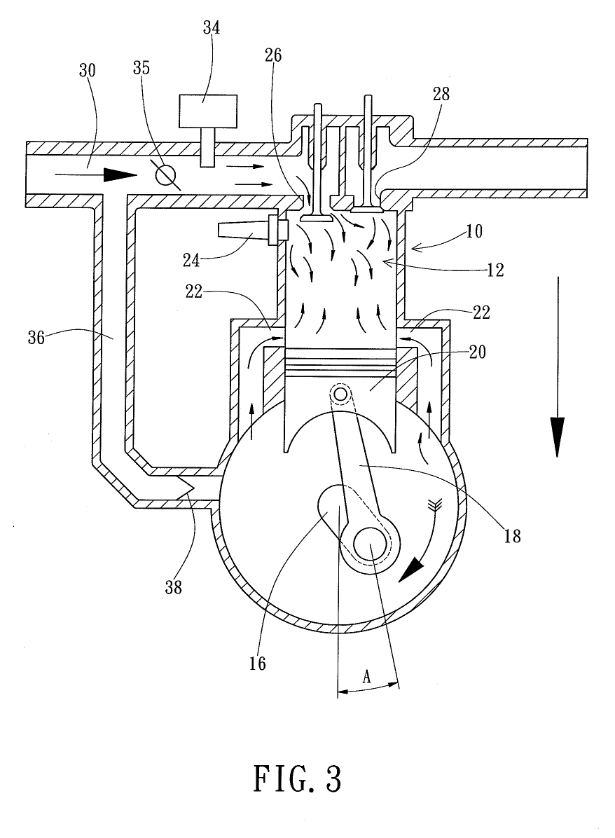

With reference to FIG. 3, during a second stage of the intake stroke, the inlet port 22 is revealed (i.e., not covered by the piston 20) when the piston 20 reaches an inlet port position about 25°-35° before the bottom dead center (see angle A in FIG. 3), so that the compressed air in the crankshaft chamber 14 enters the cylinder bore 12 via the inlet port 22. Note that the inlet port 22 remains open while the piston 20 moves from the inlet port position to the bottom dead center (i.e., the second stage of the intake stroke). Furthermore, the check valve 38 is still closed during the second stage of the intake stroke. It can be appreciated that the check valve 38 can be automatically closed during the first and second stages of the intake stroke due to compression of air in the crankshaft chamber 14 resulting from movement of the piston 20 toward the bottom dead center.

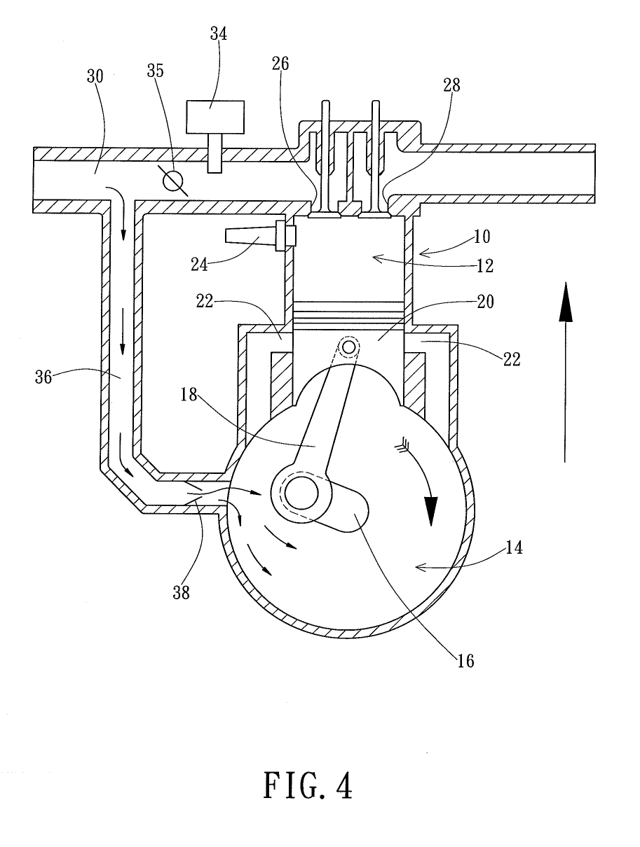

With reference to FIG. 4, during a compression stroke, the intake port 26 and the exhaust port 28 are closed, and the air-fuel mixture is compressed by the piston 20 that moves from the bottom dead center toward the top dead center. The check valve 38 is opened. Thus, air from the second intake manifold 36 passes through the check valve 38 into the crankshaft chamber 14. It can be appreciated that the check valve 38 can be automatically opened due to negative pressure resulting from movement of the piston 20 toward the top dead center.

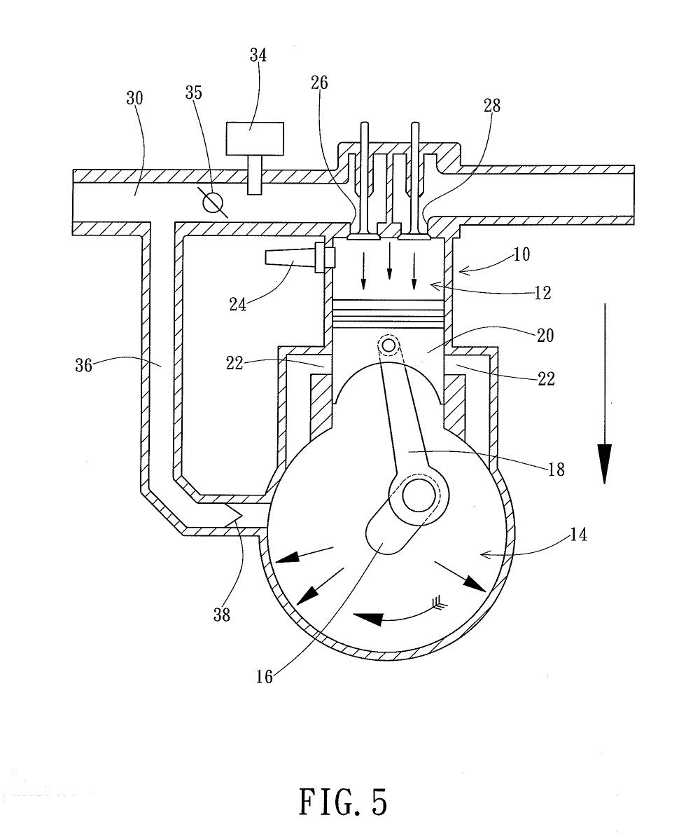

With reference to FIG. 5, during a power (or combustion) stroke, the intake port 26 and the exhaust port 28 are closed, and the air-fuel mixture in the cylinder bore 12 is ignited by the spark plug 24. The combusted gas expands to move the piston 20 toward the bottom dead center. Note that the check valve 38 is closed during the power stroke.

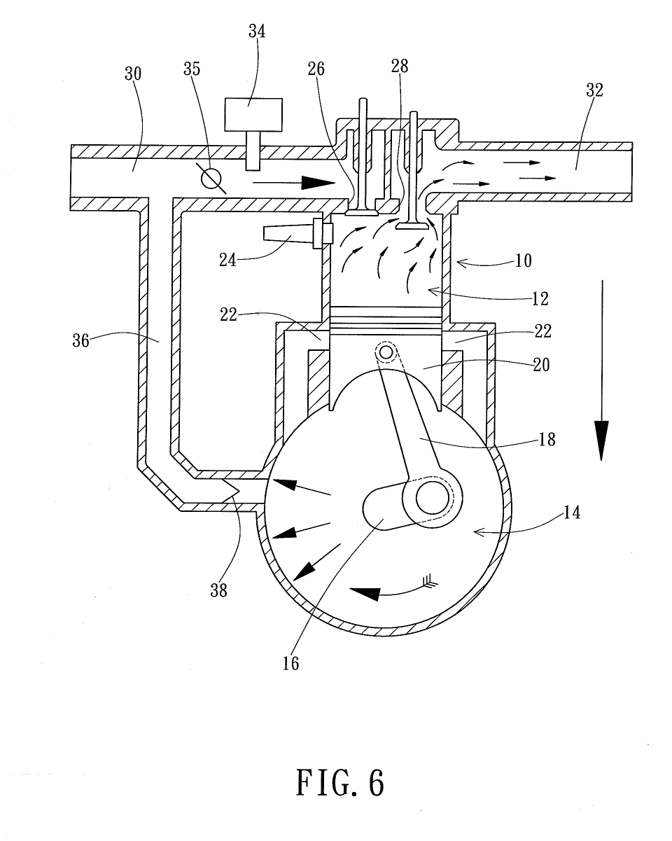

With reference to FIG. 6, when the piston 20 reaches an exhaust position about 35°-45° before the bottom dead center, the exhaust port 28 is opened while the intake port 26 remains closed. A portion of the exhaust gas after combustion is discharged via the exhaust port 28 and the exhaust manifold 32. A first stage of discharge of the exhaust gas is accomplished during a first stage of the power stroke from the top dead center to the exhaust position. Note that the check valve 38 is closed during the first stage of discharge of the exhaust gas.

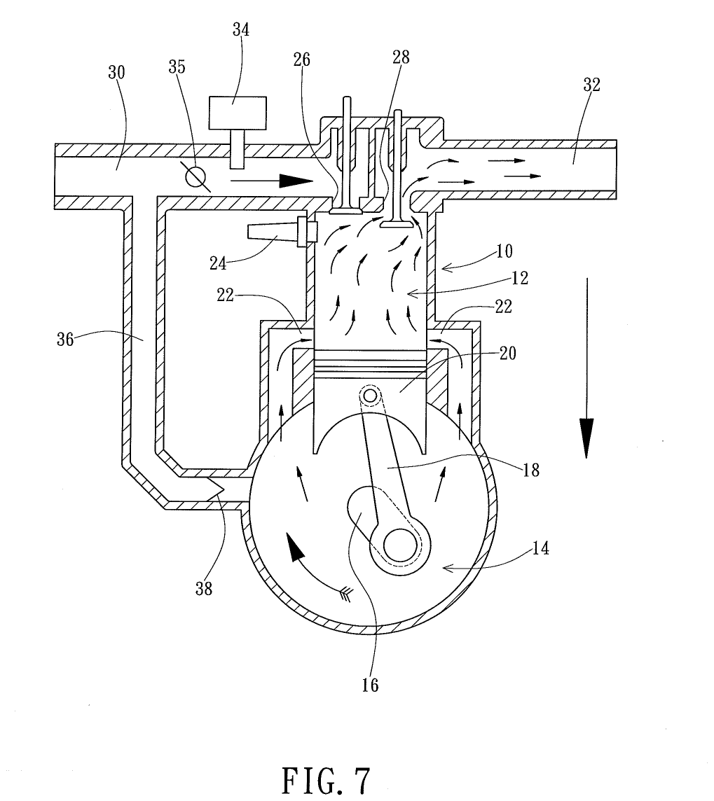

With reference to FIG. 7, when the piston 20 reaches the inlet port position about 25°-35° before the bottom dead center, the pressure in the cylinder bore 12 is reduced to a value lower than that in the crankshaft chamber 14. Thus, the air in the crankshaft chamber 14 enters the cylinder bore 12 to assist in scavenging the exhaust gas. A second-stage discharge of exhaust gas is accomplished during a second stage of the power stroke from the exhaust position to the inlet port position. Note that the check valve 38 is closed during the second-stage discharge of exhaust gas. It can be appreciated that the check valve 38 can be automatically closed during the power stroke due to compression of air in the crankshaft chamber 14 resulting from movement of the piston 20 toward the bottom dead center.

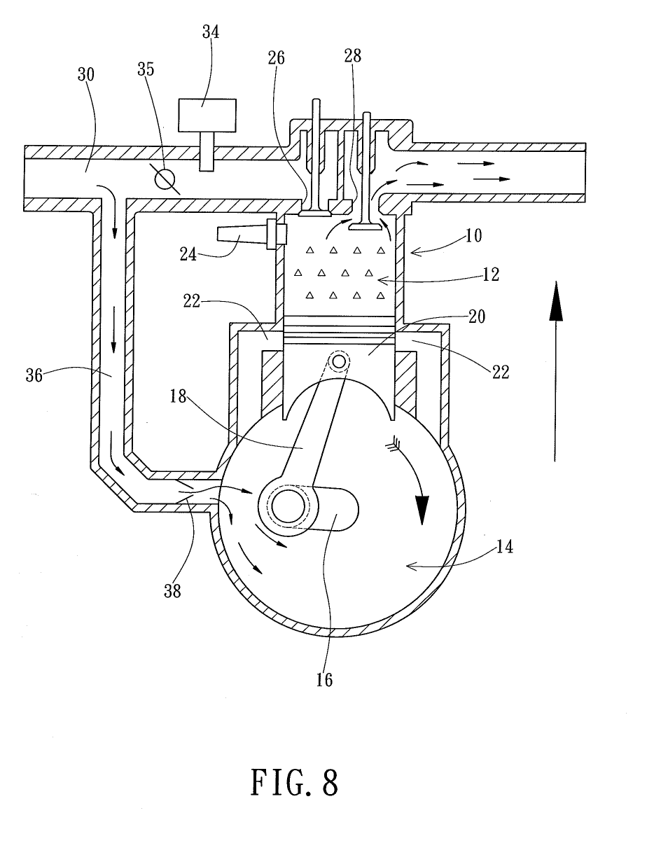

With reference to FIG. 8, when the piston 20 reaches the bottom dead center and is about to move in a reverse direction toward the top dead center, the exhaust gas is at an upper portion of the cylinder bore 12 adjacent the intake and exhaust ports 26 and 28, and the fresh air from the crankshaft chamber 14 via the inlet port 22 is at a lower portion of the cylinder bore 12 adjacent the inlet port 22. The check valve 38 is opened to introduce air into the crankshaft chamber 14.

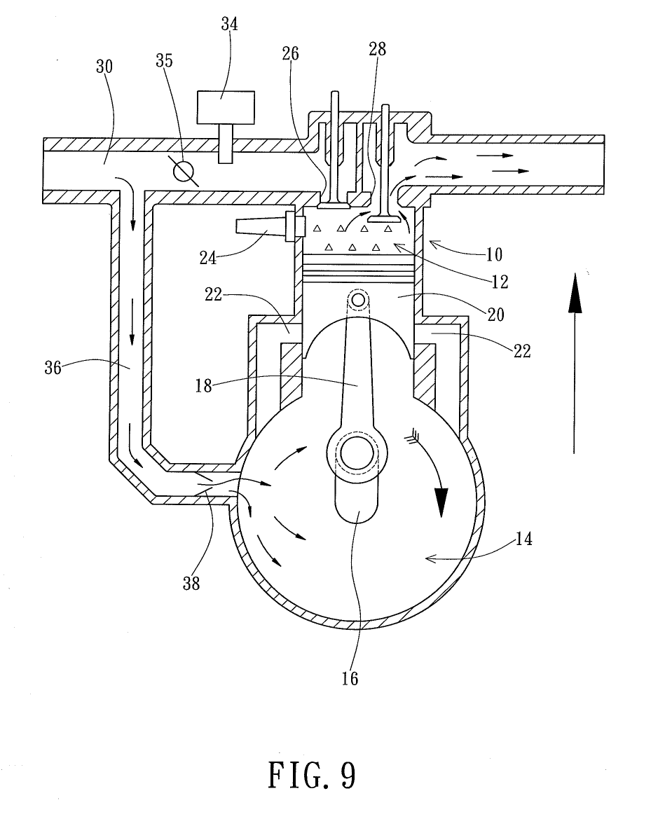

With reference to FIG. 9, the exhaust stroke ends when the piston 20 reaches the top bottom center. Namely, a third-stage discharge of the exhaust gas out of the cylinder bore 12 via the exhaust port 28 is accomplished during the exhaust stroke. Furthermore, fresh air remains in the cylinder bore 12. It can be appreciated that the check valve 38 can be automatically opened due to negative pressure resulting from movement of the piston 20 toward the top dead center. Thus, air is drawn into the crankshaft chamber 14 via the check valve 38.

The above procedures repeat in sequence to drive the crankshaft 16 to rotate continuously.

The carburetor 34 is mounted in an appropriate position in the first intake manifold 30, so that the gas entering the crankshaft chamber 14 can be fuel, air or a mixture of air and fuel. If the gas to be introduced the crankshaft chamber 14 is fuel, the carburetor 34 should be in a position before an intersection of the first and second intake manifolds 30 and 36. In the preferred form shown in FIGS. 1-9, the gas entering the crankshaft chamber 14 is mainly air. In this case, an optimal fuel/air ration in the cylinder bore 12 can be obtained by adjusting the fuel/air ratio of the carburetor 34.

By providing the second intake manifold 36 in communication with the crankshaft chamber 14 and by controlling input of gas into the crankshaft chamber 14 via the second intake manifold 36 through the check valve 38 to provide two-stage intake, fresh fuel/air mixture or fresh air can be introduced into the crankshaft chamber 14 and enter the cylinder bore 12 via the inlet port 22 at proper timing, and the exhaust gas after combustion can be scavenged out of the cylinder bore 12. Thus, the exhaust gas can be effectively discharged in each cycle, the fresh fuel/air mixture or fresh air is left in the cylinder bore 12 after the exhaust stroke. Thus, the problem of inefficient discharge of the exhaust gas encountered in conventional four-stroke internal combustion engines are fixed by the four-stroke internal combustion engine according to the preferred teachings of the present invention. Furthermore, the four-stroke internal combustion engine according to the preferred teachings of the present invention allows 100% volumetric efficiency in the intake stroke. The power of the engine is increased and the performance of the engine is enhanced while reducing pollution.

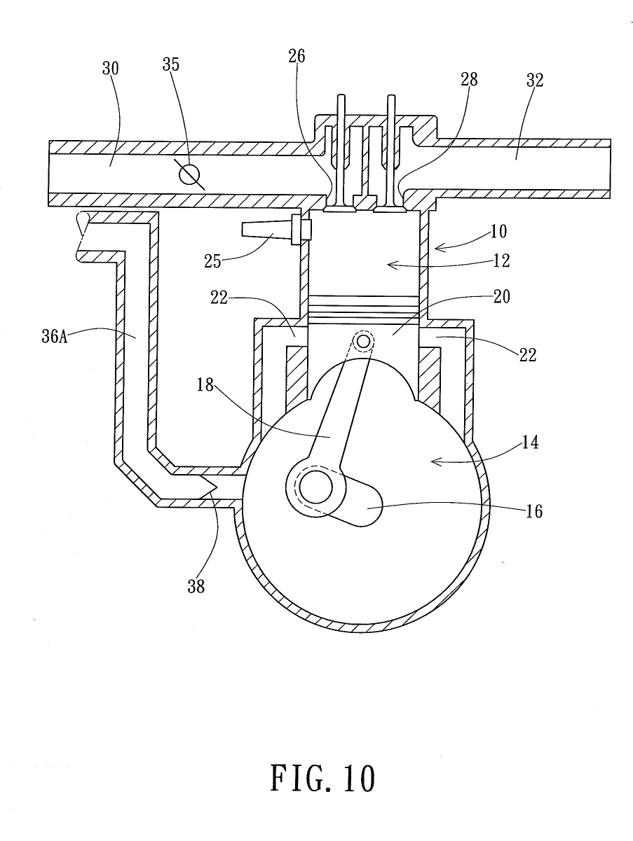

FIG. 10 shows a four-stroke internal combustion engine of a second embodiment according to the teachings of the present invention modified from the first embodiment. Specifically, instead of using the carburetor 34, the throttle 35, and the spark plug 24 of the first embodiment, the engine of the second embodiment includes a fuel injection nozzle 25 mounted to the cylinder 10 adjacent the intake and exhaust ports 26 and 28. Furthermore, the end of the second intake manifold 36A is open and not in communication with the first intake manifold 30. Thus, ambient gas or air can enter the crankshaft chamber 14 via the second intake manifold 36 for supplying air into the cylinder bore 12 and for assisting in scavenging the exhaust gas. Air can be fed to both the first and second intake manifold 30 and 36A. The piston 20 compresses the air in the cylinder bore 12 during the compression stroke, and atomized diesel is injected by the fuel injection nozzle 25 into the cylinder bore 12 for combustion purposes under high pressure and high temperature. Thus, the internal combustion engine can be utilized as a four-stroke diesel engine.

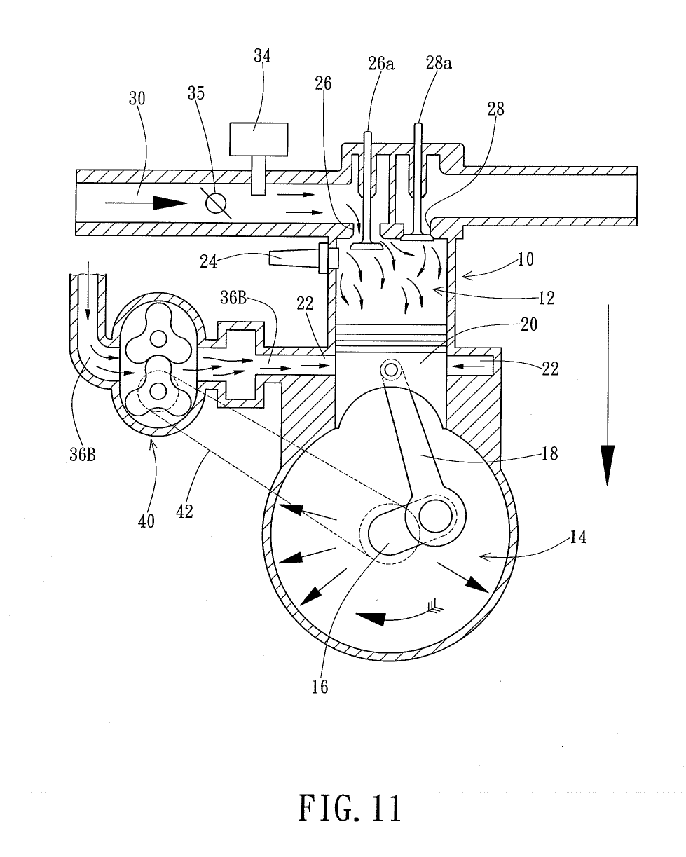

FIGS. 11-18 show a four-stroke internal combustion engine of a third embodiment according to the preferred teachings of the present invention modified from the first embodiment. Specifically, the end of the second intake manifold 36B is open and not in communication with the first intake manifold 30. The other end of the second intake manifold 36B is in communication with the inlet port 22. Furthermore, an air compressor 40 is mounted on the second intake manifold 36B. The air compressor 40 can be driven by the crankshaft 16 via a transmission device 42 such as a belt or gears and a chain. Thus, gas/air entering the second intake manifold 36B can be driven by the air compressor 40 into the crankshaft chamber 14.

With reference to FIG. 11, during a first stage of an intake stroke, the intake port 26 is open and the exhaust port 28 is closed. The piston 20 moves from its top dead center toward its bottom dead center. Air/fuel mixture from the first intake manifold 30 and the carburetor 34 is drawn into the cylinder bore 12. Note that the inlet port 22 is not in communication with the cylinder bore 12, since the piston 20 covers the inlet port 22. It can be appreciated that air in the crankshaft chamber 14 is compressed.

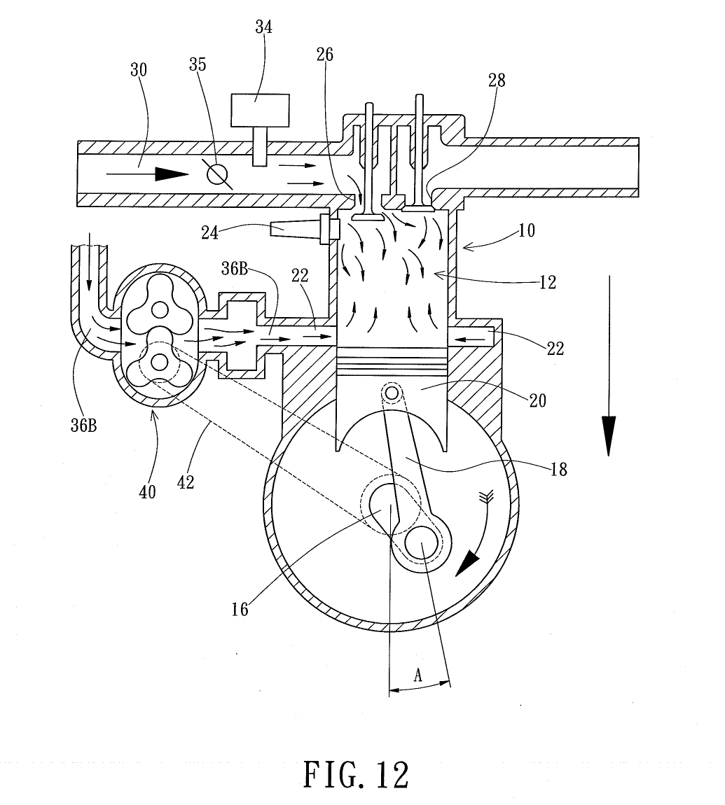

With reference to FIG. 12, during a second stage of the intake stroke, the inlet port 22 is revealed (i.e., not covered by the piston 20) when the piston 20 reaches an inlet port position about 25°-35° before the bottom dead center (see angle A in FIG. 12), so that air supplied from the air compressor 40 to the inlet port 22 enters the cylinder bore 12. Note that the inlet port 22 remains open while the piston 20 moves from the inlet port position to the bottom dead center (i.e., the second stage of the intake stroke).

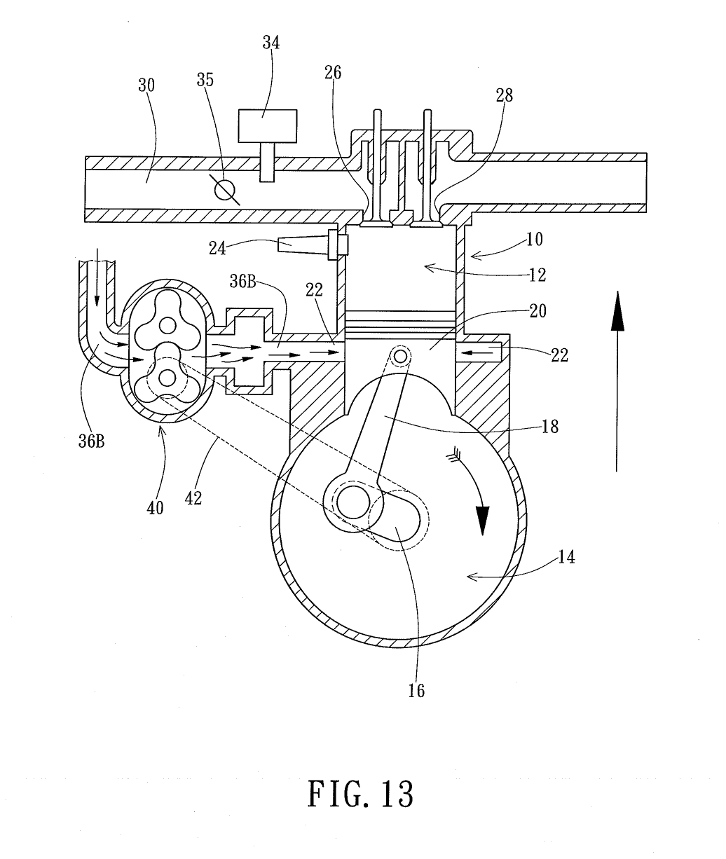

With reference to FIG. 13, during a compression stroke, the intake port 26 and the exhaust port 28 are closed, and the air-fuel mixture is compressed by the piston 20 that moves from the bottom dead center toward the top dead center. The inlet port 22 is closed by the piston 20 such that air from the air compressor 40 cannot enter the cylinder bore 12.

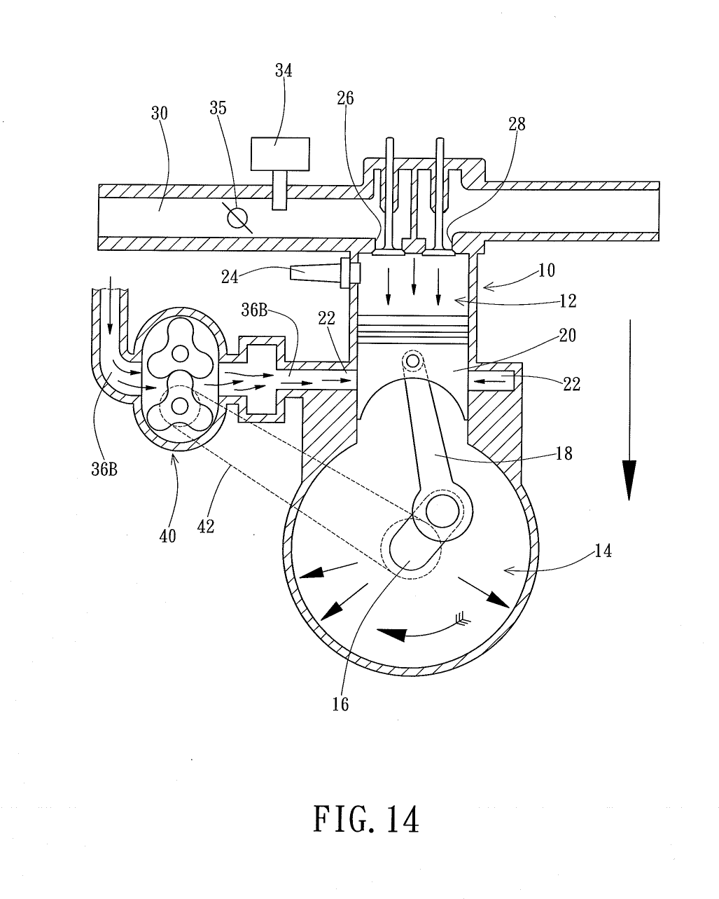

With reference to FIG. 14, during a power (or combustion) stroke, the intake port 26 and the exhaust port 28 are closed, and the air-fuel mixture in the cylinder bore 12 is ignited by the spark plug 24. The combusted gas expands to move the piston 20 toward the bottom dead center. Note that the inlet port 22 is closed during the power stroke.

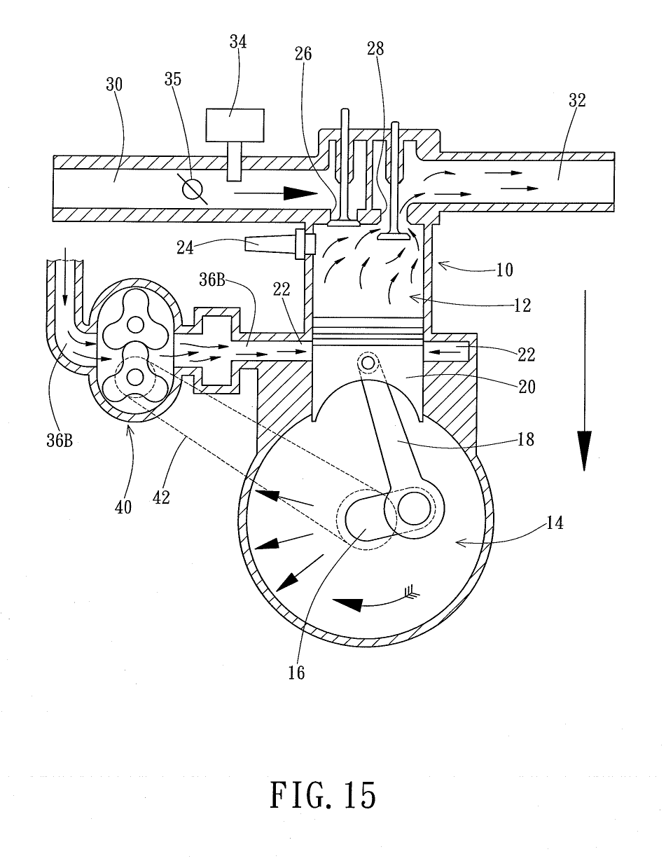

With reference to FIG. 15, when the piston 20 reaches an exhaust position about 35°-45° before the bottom dead center, the exhaust port 28 is opened while the intake port 26 remains closed. A portion of the exhaust gas after combustion is discharged via the exhaust port 28 and the exhaust manifold 32. A first stage of discharge of the exhaust gas is accomplished during a first stage of the power stroke from the top dead center to the exhaust position. Note that the inlet port 22 is closed during the first stage of discharge of the exhaust gas.

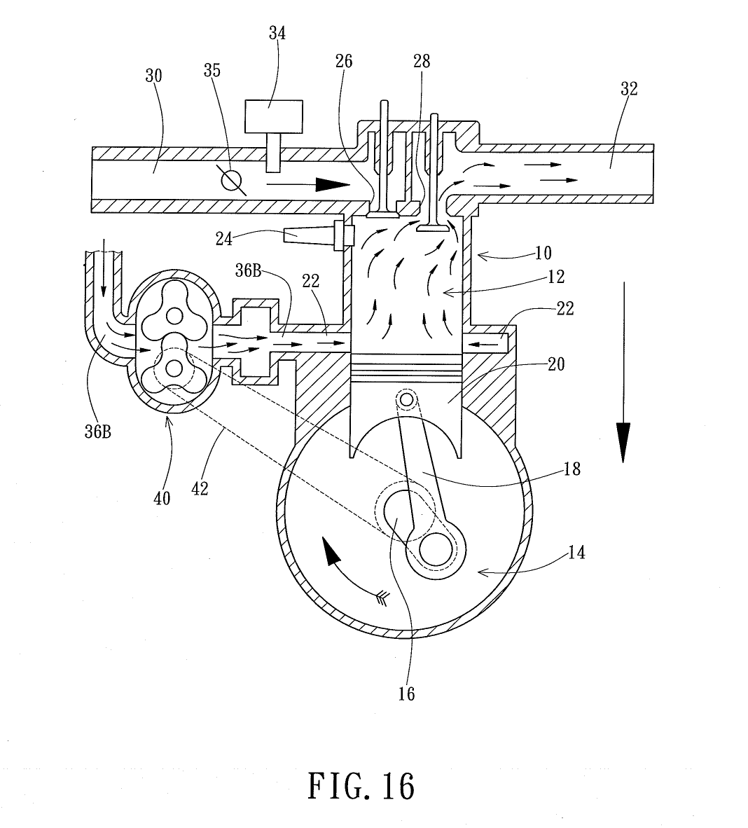

With reference to FIG. 16, when the piston 20 reaches the inlet port position about 25°-35° before the bottom dead center, the inlet port 22 is revealed such that the air supplied from the air compressor 40 enters the cylinder bore 12 to assist in scavenging the exhaust gas. A second-stage discharge of exhaust gas is accomplished during a second stage of the power stroke from the exhaust position to the inlet port position.

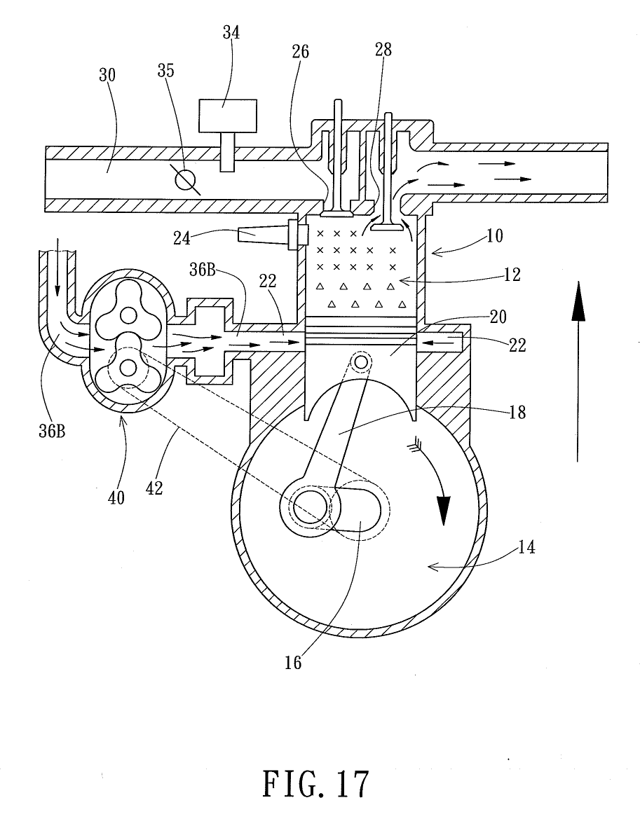

With reference to FIG. 17, when the piston 20 reaches the bottom dead center and is about to move in a reverse direction toward the top dead center, the exhaust gas is at an upper portion of the cylinder bore 12 adjacent the intake and exhaust ports 26 and 28, and the fresh air from the inlet port 22 is at a lower portion of the cylinder bore 12 adjacent the inlet port 22.

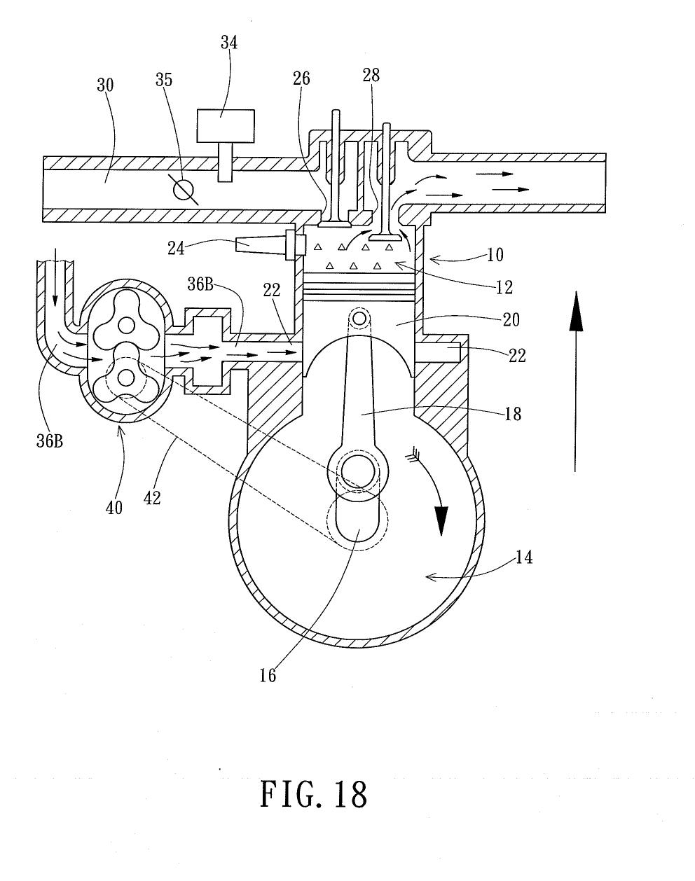

With reference to FIG. 18, the exhaust stroke ends when the piston 20 reaches the top bottom center. Namely, a third-stage discharge of the exhaust gas out of the cylinder bore 12 via the exhaust port 28 is accomplished during the exhaust stroke. Furthermore, fresh air remains in the cylinder bore 12.

The above procedures repeat in sequence to drive the crankshaft 16 to rotate continuously.

By providing the second intake manifold 36B in communication with the crankshaft chamber 14 and by supplying gas into the second intake manifold 36B by the air compressor 40 to provide two-stage intake, fresh fuel/air mixture or fresh air can be introduced into the cylinder bore 12 via the inlet port 22 at proper timing, and the exhaust gas after combustion can be scavenged out of the cylinder bore 12. Thus, the exhaust gas can be effectively discharged in each cycle, the fresh fuel/air mixture or fresh air is left in the cylinder bore 12 after the exhaust stroke. Thus, the problem of inefficient discharge of the exhaust gas encountered in conventional four-stroke internal combustion engines are fixed by the four-stroke internal combustion engine according to the preferred teachings of the present invention. Furthermore, the four-stroke internal combustion engine according to the preferred teachings of the present invention allows 100% volumetric efficiency in the intake stroke. The power of the engine is increased and the performance of the engine is enhanced while reducing pollution.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A four-stroke internal combustion engine comprising:
a cylinder including a cylinder bore, an intake port in communication with the cylinder bore, and an exhaust port in communication with the cylinder bore;
a piston received in the cylinder bore and reciprocatingly moveable in the cylinder bore;
a crankshaft chamber in communication with the cylinder bore, with the crankshaft chamber including an inlet port adjacent the cylinder bore;
a crankshaft rotatably received in the crankshaft chamber;
a connecting rod including a first end coupled to the piston and a second end coupled to the crankshaft;
a first intake manifold in communication with the intake port, with the first intake manifold supplying a first gas into the cylinder bore when the intake port is open;
an exhaust manifold in communication with the exhaust port; and
a second intake manifold in communication with the crankshaft chamber.

2. The four-stroke internal combustion engine as claimed in claim 1, further comprising: a carburetor mounted to the first intake manifold and a spark plug mounted to the cylinder, with the first gas being a fuel/air mixture.

3. The four-stroke internal combustion engine as claimed in claim 1, further comprising: a fuel injection nozzle mounted to the cylinder for injecting atomized diesel into the cylinder bore, with the first gas being air.

4. The four-stroke internal combustion engine as claimed in claim 1, further comprising a check valve mounted on a passageway formed by the second intake manifold and the intake manifold, with the check valve allowing flow of a second gas from the second intake manifold into the crankshaft chamber and not allowing flow of the second gas from the crankshaft chamber into the second intake manifold.

5. The four-stroke internal combustion engine as claimed in claim 4, with the second intake manifold interconnected between the crankshaft chamber and the first intake manifold.

6. The four-stroke internal combustion engine as claimed in claim 1, further comprising: an air compressor mounted on the second intake manifold, with the air compressor supplying a second gas into the crankshaft chamber.

7. The four-stroke internal combustion engine as claimed in claim 6, with the air compressor being coupled to and driven by the crankshaft.

8. The four-stroke internal combustion engine as claimed in claim 6, with the second intake manifold being coupled to the inlet port of the crankshaft chamber.

9. A four-stroke internal combustion engine comprising:
a cylinder including a cylinder bore, an intake port in communication with the cylinder bore, and an exhaust port in communication with the cylinder bore;
a piston received in the cylinder bore and reciprocatingly moveable between a top dead center and a bottom dead center, with the piston including an intake stroke, a compression stroke, a power stroke, and an exhaust stroke;
a crankshaft chamber in communication with the cylinder bore, with the crankshaft chamber including an inlet port adjacent the cylinder bore;
a crankshaft rotatably received in the crankshaft chamber;
a connecting rod including a first end coupled to the piston and a second end coupled to the crankshaft;
a first intake manifold in communication with the intake port;
an exhaust manifold in communication with the exhaust port; and
a second intake manifold in communication with the crankshaft chamber,
with the intake port being open and the exhaust port being closed during the intake stroke, with a first gas entering the cylinder bore via the intake port, with the intake stroke including a first stage and a second stage, with the first stage of the intake stroke including movement of the piston from the top dead center to an inlet port position about 25°-35° before the bottom dead center, with the second stage of the intake stroke including movement of the piston from the inlet port position to the dead bottom center, with the inlet port being covered by the piston during the first stage of the intake stroke, with the inlet port being not covered by the piston during the second stage of the intake stroke, with a second gas in the crankshaft chamber flowing into the cylinder bore via the inlet port during the second stage of the intake stroke,
with the intake port and the exhaust port being closed during the compression stroke of the piston, with the first gas being compressed during the compression stroke,
with the power stroke including a first stage, a second stage, and a third stage, with the first stage of the power stroke including movement of the piston from the top dead center to an exhaust position about 35°-45° before the bottom dead center, with the second stage of the power stroke including movement of the piston from the exhaust position to the inlet port position, with the third stage of the power stroke including movement of the piston from the inlet port position to the dead bottom center,
with the intake port and the exhaust port being closed and the inlet port being covered by the piston during the first stage of the power stroke, with the first gas being combusted at a beginning of the first stage of the power stroke,
with the exhaust port being open and the intake port being closed and with the inlet port covered by the piston during the second stage of the power stroke, with a portion of exhaust gas after combustion of the first gas being discharged via the exhaust port during the second stage of the power stroke, accomplishing a first stage of discharge of the exhaust gas,
with the exhaust port being open and the intake port being closed and with the inlet port being not covered by the piston and with the second gas in the crankshaft chamber entering the cylinder bore via the inlet port during the third stage of the power stroke, performing a second-stage discharge of the exhaust gas via the exhaust port,
with the exhaust port being opened and the inlet port closed during the exhaust stroke, with the exhaust gas not discharged in the third stage of the power stroke being discharged via the exhaust port during the exhaust stroke, and with fresh second gas entering the crankshaft chamber via the second intake manifold during the exhaust stroke.

10. The four-stroke internal combustion engine as claimed in claim 9, further comprising a check valve mounted on the second intake manifold, with the check valve allowing flow of the second gas from the second intake manifold into the crankshaft chamber and not allowing flow of the second gas from the crankshaft chamber into the second intake manifold.

11. The four-stroke internal combustion engine as claimed in claim 10, with the second gas in the crankshaft chamber being compressed during the first stage of the intake stroke and during the first and second stages of the power stroke, with the second gas compressed at the first stake of the intake stroke entering the cylinder bore via the inlet port during the second stage of the intake stroke.

12. The four-stroke internal combustion engine as claimed in claim 11, with the check valve being opened during the compression stroke, supplying the second gas from the second intake manifold into the crankshaft chamber during the compression stroke.

13. The four-stroke internal combustion engine as claimed in claim 12, with the check valve being opened due to a first negative pressure resulting from movement of the piston toward the top dead center during the compression stroke.

14. The four-stroke internal combustion engine as claimed in claim 13, with the check valve being closed during the power stroke, and with the check valve being opened to a second negative pressure resulting from movement of the piston toward the top dead center during the exhaust stroke.

15. A four-stroke internal combustion engine comprising:
a cylinder including a cylinder bore, an intake port in communication with the cylinder bore, and an exhaust port in communication with the cylinder bore;
a piston received in the cylinder bore and reciprocatingly moveable between a top dead center and a bottom dead center, with the piston including an intake stroke, a compression stroke, a power stroke, and an exhaust stroke;
a crankshaft chamber in communication with the cylinder bore, with the crankshaft chamber including an inlet port adjacent the cylinder bore;
a crankshaft rotatably received in the crankshaft chamber;
a connecting rod including a first end coupled to the piston and a second end coupled to the crankshaft;
a first intake manifold in communication with the intake port for supplying a first gas into the cylinder bore via the intake port;
an exhaust manifold in communication with the exhaust port;
a second intake manifold including an end connected to and in communication with the inlet port; and
an air compressor mounted on the second intake manifold, with the air compressor allowing flow of a second gas from the second intake manifold into the inlet port and not allowing flow of the second gas from the inlet port into the second intake manifold,
with the intake port being open and the exhaust port being closed during the intake stroke, with the first gas entering the cylinder bore via the intake port, with the intake stroke including a first stage and a second stage, with the first stage of the intake stroke including movement of the piston from the top dead center to an inlet port position about 25°-35° before the bottom dead center, with the second stage of the intake stroke including movement of the piston from the inlet port position to the dead bottom center, with the inlet port being covered by the piston during the first stage of the intake stroke, with the inlet port being not covered by the piston during the second stage of the intake stroke, with the air compressor supplying the second gas from the second intake manifold into the cylinder bore via the inlet port during the second stage of the intake stroke,
with the intake port and the exhaust port being closed during the compression stroke of the piston, with the first gas being compressed during the compression stroke,
with the power stroke including a first stage, a second stage, and a third stage, with the first stage of the power stroke including movement of the piston from the top dead center to an exhaust position about 35°-45° before the bottom dead center, with the second stage of the power stroke including movement of the piston from the exhaust position to the inlet port position, with the third stage of the power stroke including movement of the piston from the inlet port position to the dead bottom center,
with the intake port and the exhaust port being closed and the inlet port being covered by the piston during the first stage of the power stroke, with the first gas being combusted at a beginning of the first stage of the power stroke,
with the exhaust port being open and the intake port being closed and with the inlet port being not covered by the piston during the second stage of the power stroke, with a portion of exhaust gas after combustion of the first gas being discharged via the exhaust port during the second stage of the power stroke, accomplishing a first stage of discharge of the exhaust gas,
with the exhaust port being open and the intake port being closed and with the inlet port being not covered by the piston and with the air compressor supplying the second gas from the second intake manifold into the cylinder bore via the inlet port during the third stage of the power stroke, performing a second-stage discharge of the exhaust gas via the exhaust port,
with the exhaust port being opened and the inlet port closed during the exhaust stroke, with the exhaust gas not discharged in the third stage of the power stroke being discharged via the exhaust port during the exhaust stroke.

16. The four-stroke internal combustion engine as claimed in claim 15, with the second intake manifold including another end not connected to the first intake manifold.

17. The four-stroke internal combustion engine as claimed in claim 15, with the air compressor being coupled to and driven by the crankshaft.
